(19) United States
(12) Patent Application Publication
(10) Pub. No.: US 2026/0200023 A1
(43) Pub. Date: Jul. 16, 2026

(54) SELF-PIERCING CLINCH FASTENER INSTALLATION PRESS WITH INTENSIFICATION RAM

(71) Applicant: Doben Limited, Windsor (CA)

(72) Inventor: David M. Simone, Amherstburg (CA)

(21) Appl. No.: 19/136,151

(22) PCT Filed: Jul. 26, 2024
(86) PCT No.: PCT/CA2024/051003

§ 371 Date: Jun. 5, 2025

Related U.S. Application Data
(60) Provisional application No. 63/529,127, filed on Jul. 26, 2023.

(51) Int. Cl. B23P 19/06

(52) U.S. Cl. CPC B23P 19/062

(57) ABSTRACT

A clinching press includes a head assembly mounted to a ram to engage a fastener. A pin is slidably supported within the head assembly and extends out of the head assembly to a tip that locates the fastener. The head assembly includes an eject piston that is arranged in a hydraulic cylinder arranged on one side of the eject piston. The pin is operatively connected to the eject piston. A valve is fluidly interconnected between a hydraulic fluid source and the hydraulic chamber. The valve is configured to selectively provide the hydraulic fluid to the hydraulic chamber. A controller is in communication with the valve to command the valve to supply the hydraulic fluid to the hydraulic chamber with the ram in an advanced position to move the pin to a slug-eject position.

### CROSS-REFERENCE TO RELATED APPLICATION

This application claims priority to U.S. Provisional Application No. 63/529,127 filed on Jul. 26, 2023, and which is incorporated herein by reference in its entirety.

### TECHNICAL FIELD

This disclosure relates to a clinching press for securing a fastener (e.g., nut) to a workpiece, such as sheet metal. More particularly, this disclosure relates to a hydraulic head assembly for pressing the fastener while sensing fastener position, and to a hydraulic ram used with the head assembly.

### BACKGROUND

Clinching presses are used to secure clinch fasteners to metallic objects such as body panels for vehicles. A fastener, such as a nut, is loaded onto a head assembly. The head assembly moves to press a fastener against the panel until the panel engages a die with pressure sufficient to cause the fastener to pierce the panel and mechanically interlock with it. A slug is sheared from the workpiece during the clinching process.

Fastener loading onto the head assembly of the clinching presses is typically an automated process to minimize the fastener loading time, improve process reliability, and reduce pinch point hazards. Occasionally, the fastener is not properly loaded into the head assembly or the fastener may not be loaded into the head assembly at all. When an operator is manipulating a panel into position for fastener installation, the operator may visually identify fault conditions before or after the clinching press has performed the installation cycle. Sensors are used in an effort to determine the presence and orientation of the fastener in the clinching press.

Although clinching presses with better sensing have been greatly improved accuracy and reliability, incomplete slug displacement remains a long-standing issue because it frequently results from tooling wear and what amounts to improper application of the clinch fastener(s).

### SUMMARY

In one exemplary embodiment, a clinching press for performing a clinching operation to secure a fastener to a workpiece, the fastener clinching press includes a frame that supports a die having a hole that is configured to cooperate with the fastener to produce a slug from the workpiece, a pressure cylinder that is supported by the frame, a ram that extends from the pressure cylinder and is configured to move between a returned position and an advanced position. A head assembly is mounted to the ram and configured to engage the fastener in the advanced position. A pin is slidably supported within the head assembly and extends out of the head assembly to a tip that is configured to locate the fastener relative to the die. The pin is movable between multiple pin positions that include a slug-eject position. The head assembly includes an eject piston that is arranged in a hydraulic cylinder. A hydraulic chamber is arranged on one side of the eject piston and is configured to receive a hydraulic fluid. The pin is operatively connected to the eject piston. A valve is fluidly interconnected between a hydraulic fluid source and the hydraulic chamber. The valve is configured to selectively provide the hydraulic fluid to the hydraulic chamber. A controller is in communication with the valve. The controller is configured to command the valve to supply the hydraulic fluid to the hydraulic chamber with the ram in the advanced position to move the pin to the slug-eject position.

In a further embodiment of any of the above, the pressure cylinder includes a working cylinder that has a working piston that is arranged therein and connected to a working rod that provides the ram. The working piston separates the working cylinder into an advance working chamber and a retract working chamber. The advance working chamber is in fluid communication with the hydraulic fluid source.

In a further embodiment of any of the above, the pressure cylinder includes a an intensification cylinder that is divided from the working cylinder by a separator block. An intensification piston and an intensification rod are arranged in the intensification cylinder. The intensification piston separates the intensification cylinder into an advance intensification chamber and a retract intensification chamber. The intensification rod is configured to be disposed in the advance working chamber in an intensified state.

In a further embodiment of any of the above, the clinching press includes a fluid source that is in fluid communication with the retract working chamber and the retract intensification chamber

In a further embodiment of any of the above, the clinching press includes a fluid source that is in fluid communication with the advance intensification chamber.

In a further embodiment of any of the above, the intensified state corresponds to a clinch state in which the fastener is secured to the workpiece, and the controller commands the valve to supply the hydraulic fluid to the hydraulic chamber in the intensified state.

In a further embodiment of any of the above, the valve fluidly interconnects the advance working chamber and the hydraulic chamber.

In a further embodiment of any of the above, the head assembly includes a return spring that is operatively connected to the piston on a side opposite the hydraulic chamber.

In a further embodiment of any of the above, the return spring is coaxial with the eject piston.

In a further embodiment of any of the above, the eject piston is coaxial with the pin.

In a further embodiment of any of the above, the valve is a directional valve that includes a first position that fluidly blocks fluid flow from the hydraulic fluid source to the hydraulic chamber, and a second position that fluidly connects the hydraulic fluid source to the hydraulic chamber.

In a further embodiment of any of the above, the head assembly includes a magnet that is configured to maintain the fastener in engagement with the head assembly during the clinching operation.

In a further embodiment of any of the above, the clinching press includes a fastener feeder that has a shuttle with an end configured to receive a fastener. The shuttle is mounted to a shuttle cylinder that is configured to move the shuttle between a shuttle extended position and a shuttle retracted position. A lift cylinder is configured to pivot the shuttle cylinder between a first position configured to arrange the fastener in spaced relation to the head assembly and a second position configured to arrange the fastener in engagement with the head assembly.

In a further embodiment of any of the above, an assembly cell including the clinching press, the assembly cell includes a multi-axis robot that is configured to transfer the workpiece to and from the clinching press for the clinching operation.

In a further embodiment of any of the above, the assembly cell includes a conveyor that is configured to feed the workpiece to the multi-axis robot.

In another exemplary embodiment, a method of performing a clinching operation includes positioning a fastener beneath a head assembly with a pin that extends into and in engagement with the fastener, advancing the head assembly and the pin toward a die, engaging a workpiece between the die and the head assembly to pierce the workpiece with the fastener during a clinching operation, and supplying hydraulic fluid to the head assembly to advance the pin and push a slug from the workpiece through the die.

In a further embodiment of any of the above, the supplying step is prevented during the engaging step.

In a further embodiment of any of the above, the advancing step and the engaging step are performed by advancing a ram to which the head assembly is mounted. The ram has an advance working chamber that receives hydraulic fluid during the engaging step.

In a further embodiment of any of the above, the supplying step is controlled by a valve that fluidly connects the advance working chamber and a hydraulic chamber in the head assembly.

In a further embodiment of any of the above, the method includes the step of urging the pin to a retracted position with the head assembly in a retracted position.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic view of a cell with at least one clinching press according to the disclosed embodiments.

FIGS. 2A-2C are respectively perspective, front and side cross-sectional views of an example clinching press.

FIGS. 3A and 3B are perspective and enlarged cross-sectional views of a head assembly, die and fastener feeder.

FIG. 4 illustrates a hydraulic schematic view of a disclosed head assembly for use with an intensification cylinder, with the head assembly in a retract state.

FIG. 5 is an enlarged cross-sectional view of the head assembly shown in FIG. 4.

FIG. 6 illustrates a hydraulic schematic view of the disclosed head in an advance state.

FIG. 7 illustrates a hydraulic schematic view of the disclosed head in a check state.

FIG. 8 illustrates a hydraulic schematic view of the disclosed head in a clinch state.

FIG. 9 illustrates a hydraulic schematic view of the disclosed head in an eject state.

FIG. 10 is an enlarged cross-sectional view of the head assembly shown in FIG. 9.

FIG. 11 is a cross-sectional view of an offset head assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

The disclosed system provides low-cost automation to clinch fasteners to sheet metal stampings or other materials at high speeds.

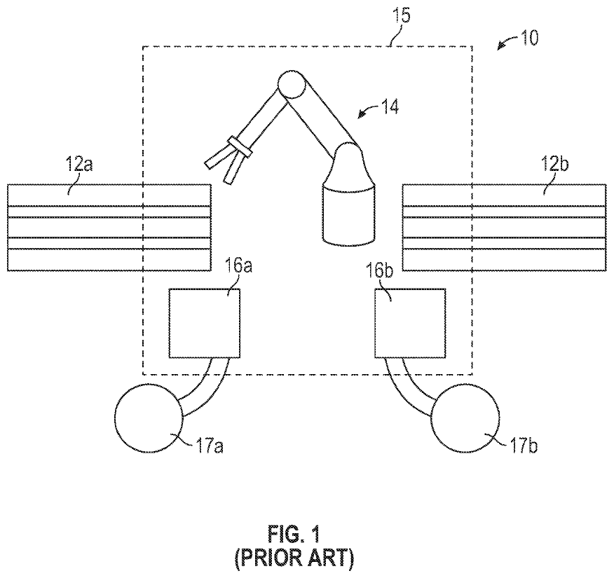

A fastener clinching system 10 is schematically illustrated in FIG. 1. First and second conveyors 12a, 12b feed different parts, such as stampings, into a multi-axis robot 14 within a cell 15. The robot 14 transfers the parts from the conveyors 12a, 12b to clinching presses 16a, 16b (generally, clinching press 16). One clinching press 16a secures a fastener supplied by a vibratory feeder bowl 17a, and the other clinching press 16b secures nuts supplied by a vibratory feeder bowl 17b (generally, vibratory feeder bowl 17). The cell arrangement shown in FIG. 1 is exemplary only and may be configured differently than illustrated, for example, fewer or more operations, which may include different operations other than clinching. An example of the disclosed clinching press is similar to that disclosed in International Patent Application No. PCT/CA2023/052312, entitled “SELF-PIERCING CLINCH FASTENER INSTALLATION PRESS”, filed on Oct. 4, 2023 and which is incorporated herein by reference in its entirety.

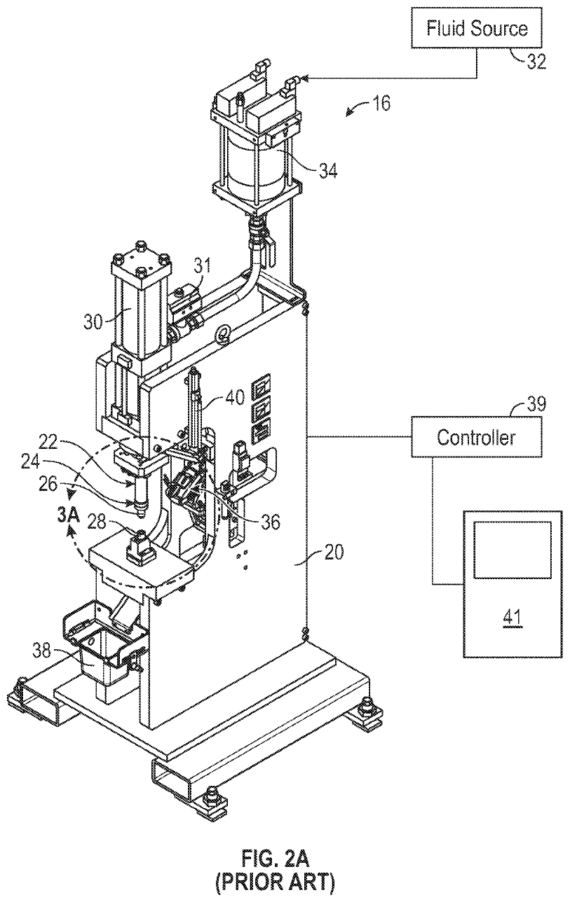

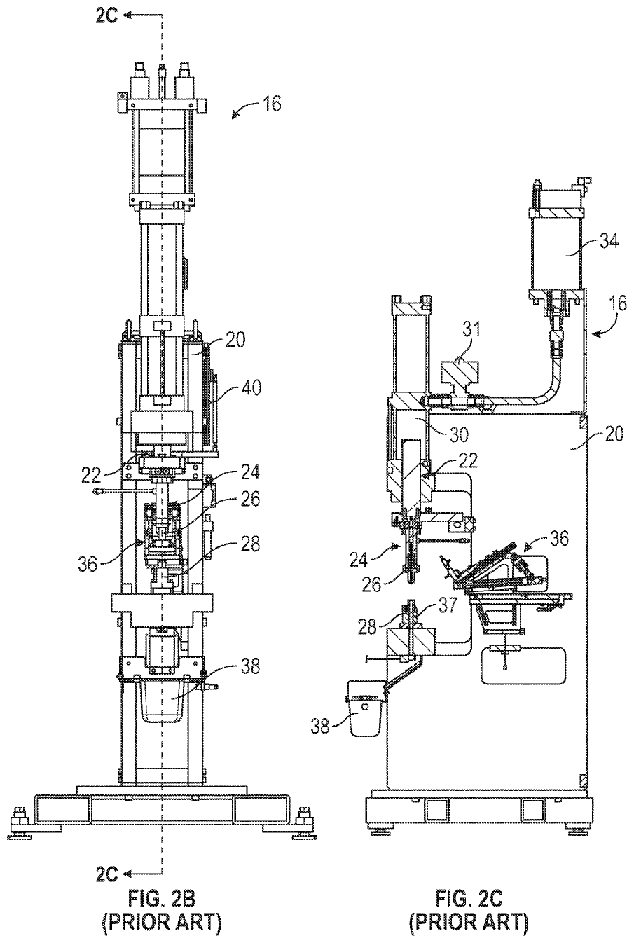

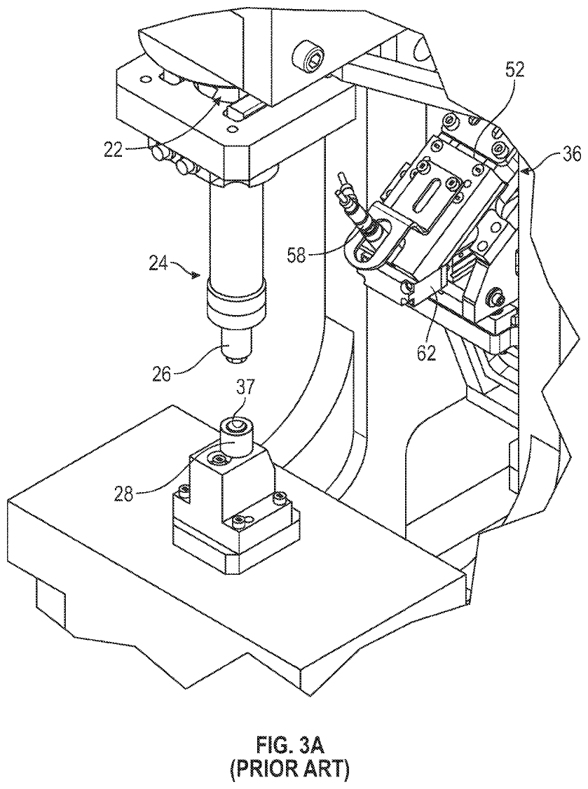

With reference to FIGS. 2A-2C, the clinching press 16 includes a frame 20 supporting a linearly moveable ram 22 that is used to force a fastener F into a workpiece against a die 28 under high forces to clinch the fastener F onto the workpiece, which is typically sheet metal. During the clinching operation, the fastener F pierces a hole into the workpiece and produces a slug, which is expelled as is known. During piercing of the workpiece with the fastener F, the slug passes through a hole 37 in the die 28 and is collected in a basket 38. A slug sensor 48 may be used to detect the slug as it travels through the hole 37, confirming the slug has separated from the workpiece.

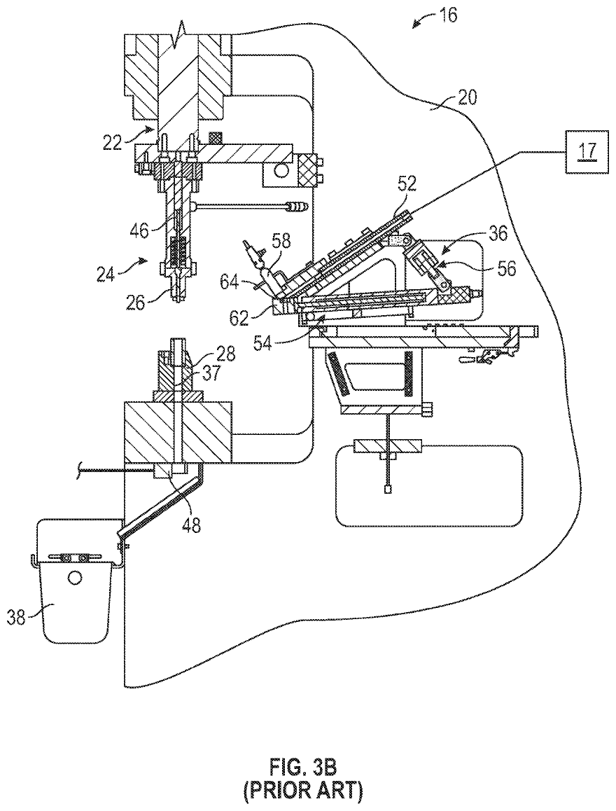

A head assembly 24 is mounted onto an end of the ram 22, which is typically arranged above the die 28 supported on the frame 20. A head 26, which acts as an upper die, is provided by the head assembly 24 which engages and supports the fastener F. The fastener F is loaded onto the head 26 by a feeder 36 that receives properly oriented fasteners F from the vibratory feeder bowl 17. As shown in FIG. 3B, this type of head assembly 24 includes a pin 44 for locating the fastener F and pushing the slug through the hole 37. The position of the pin 44 is monitored by a pin sensor 46.

The feeder 36 is supplied fasteners F from the vibratory feeder bowl 17 and must deliver those fasteners F, one-by-one, to the head 26. The feeder 36 positions the fastener to be loaded onto the head 26 for subsequent engagement with the workpiece. Referring to FIGS. 3A-3B, the feeder 36 is secured to the frame 20. The feeder 36 includes a chute 52, which delivers fasteners from the vibratory feeder bowl 17 to an end block 62 of a feed shuttle cylinder 54. The end 62 includes a pocket 64 that receives a fastener F from the chute 52. A proximity sensor 58 may be provided relative to the feeder 36 to ensure that a fastener F has in fact been loaded properly into the pocket 64. The feeder 36 includes a feed shuttle cylinder 54 is actuated to move the end block 62 between a retracted position (FIG. 3B) and an extended in which a fastener F is loaded onto the head 24, for example, using actuator 56.

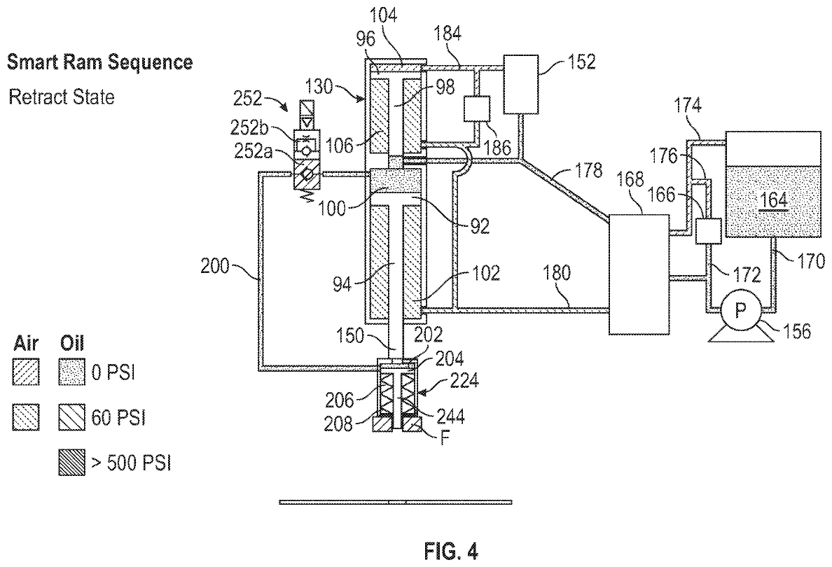

In operation, the ram 22 is actuated by a cylinder 30 that is supplied fluid from a fluid source 32 via an accumulator 34. The cylinder 30 may be an air-over-oil intensifying cylinder, for example. An example of an intensifying cylinder that may be used is described in PCT Application No. PCT/CA2023/050927, entitled “HYDRAULIC CYLINDER AND SYSTEM WITH PRESSURE INTENSIFICATION”, filed on Jul. 10, 2023 and which is incorporated herein by reference in its entirety. A control valve 31, for example, selectively supplies fluid to the cylinder 30 to expand and retract the ram 22 in response to a command from the controller 39 (FIG. 4). Although a single control valve is shown for simplicity, the hydraulic system may incorporate multiple valves working in cooperation with one another, as is the case of an intensifying cylinder. A ram sensor 40, a linear variable displacement transducer (LVDT), is typically mounted exteriorly to the frame 20 and connected to the outside of the head assembly 24 to monitor the travel of the ram 22.

All of these operations occur at relatively high speed and must be performed with accuracy in a repeatable manner. Since there are many opportunities for error due to the complexity and speed of the fastener clinching operation, it is desirable to error-proof the system 10 as much as practically possible. Referring to FIG. 2A, a fastener clinching monitor 41 is connected to controller 39 in communication with various sensors. The sensors track movements of components on the clinching press 16, which are associated with movement of the fastener throughout the clinching operation. The sensor data is used to determine useful information relating to the clinching operation, as will be appreciated from the description below. A monitor programming interface is connected to the fastener clinching monitor 41, and its data analyzed using, for example, statistical analysis software.

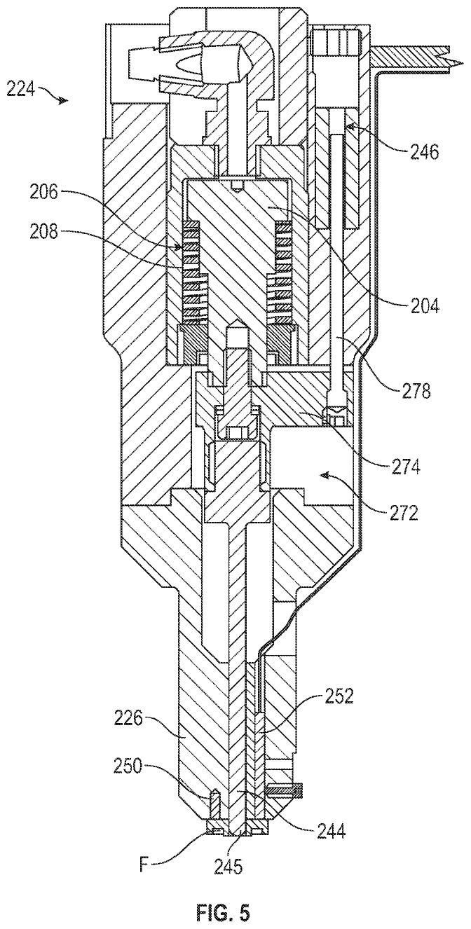

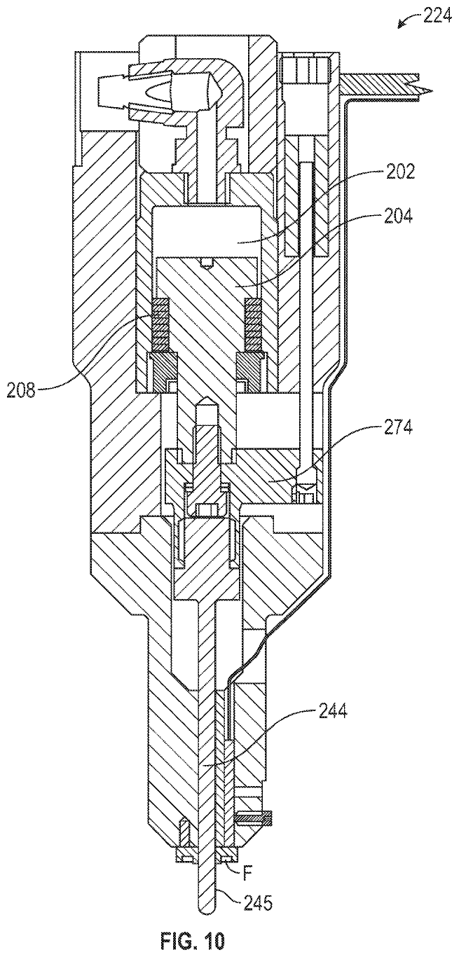

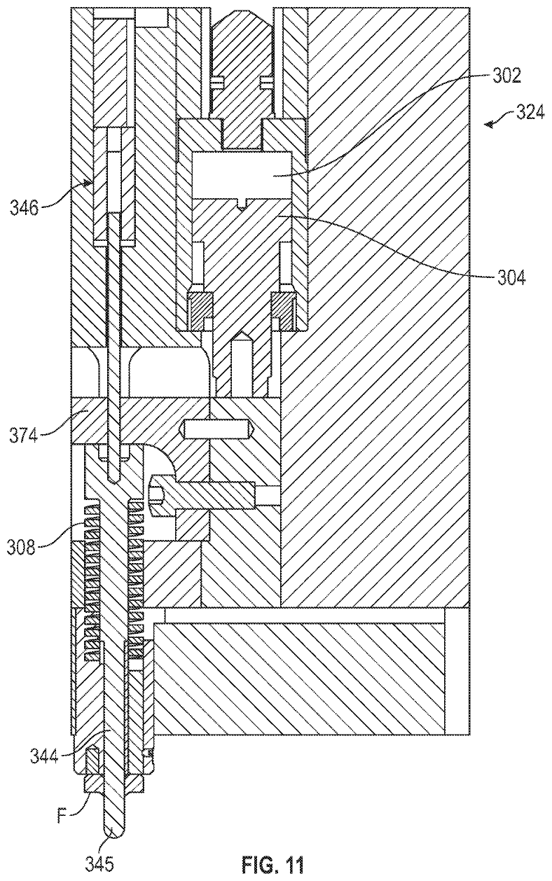

The head assembly 24 shown in FIGS. 2A-3B may not fully remove the slug from the workpiece during the clinching operation. The present disclosure incorporates a head assembly (e.g., 224 in FIGS. 5 and 10; 324 in FIG. 11) having a hydraulic chamber that generates significantly more force, which is capable of consistently and fully removing the slug.

The head assembly 224/324 directs high-pressure oil that has been produced inside the intensification cylinder (see, 130 in FIGS. 4, 6-9) to act on the ejector pin 244/344 (within the clinch fastener head assembly 224/324), so that it can develop enough force to dislodge a firmly attached slug. The cylinder 130 could for example be rated for an internal (intensification) pressure of 3,000 psi maximum, though much lower pressures could be used for the clinch operation. This force boost on the ejector pin 244/344 can be applied after the fastener F has been installed normally, while the fastener F and workpiece are fully engaged with the head 224/324 and die 28, and only when necessary. This ensures any high and potentially unbalanced load on the workpiece during separation of the base metal will not disrupt the integrity of the clinched connection(s).

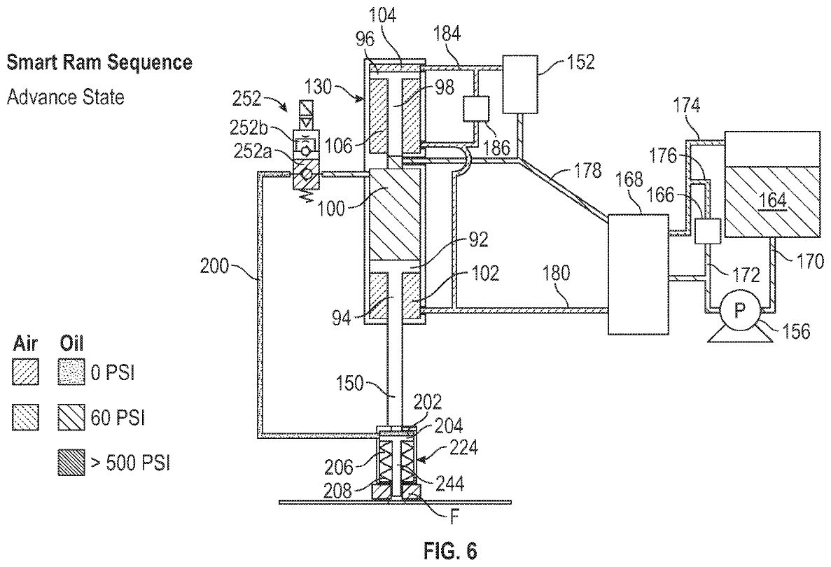

The disclosed head assembly 224/324 may be provided in an in-line configuration (FIGS. 6 and 10) or an offset configuration (FIG. 11). If a hydraulic ram is used, hydraulic fluid from the ram may be selectively supplied to the head assembly by a valve 252, as shown in FIGS. 4 and 6-9, in communication with controller 39. Otherwise, high-pressure fluid may be provided to the head assembly 224/324 from a dedicated or other hydraulic fluid source.

Referring to FIG. 4 by way of background, an example intensification cylinder 130 is shown and to which the head assembly 224 is mounted on end portion 150 (i.e., the ram that extends from the cylinder 130). The cylinder 130 includes a working cylinder (bottom half) and an intensification cylinder (top half) that are coaxially mounted with respect to one another by first and second end blocks and a separator block clamped together by fasteners. It should be understood that the working cylinder and intensification cylinder may be decoupled from one another for packaging, if desired. As shown in FIGS. 4 and 6-9, the working cylinder houses a working piston 92 from which a working rod 94 extends through the first end block to the end portion 150. The end portion 150 translates longitudinally during operation to cooperate with the workpiece. The working piston 92 separates the working cylinder into an advance working chamber 100 and a retract working chamber 102.

The intensification cylinder houses an intensification piston 96 from which an intensification rod 98 extends at least partially into the separator block. The intensification piston 96 separates the intensification cylinder into an advance intensification chamber 104 and a retract intensification chamber 106. It should be understood that the pressure cylinder 30 includes various seals, which are not shown, but known in the cylinder art. The intensification rod 98 extends into the separator block. When intensification, or amplification of the pressure in the advance working chamber 100 is desired, the intensification rod 98 is advanced to prevent fluid from escaping the advance working chamber 100. At that point, pressure applied to the intensification piston 96 acts upon the smaller diameter of the intensification rod 98 causing it to raise the pressure in the advance working chamber 100, with the pressure increase proportional to the ratio of the areas of the intensification piston 96 and intensification rod 98. Because the volume of fluid displaced by the intensification rod 98 is comparatively small when compared to the volume of the advance working chamber 100, the intensification piston 96 has to stroke a proportionally long distance to cause displacement of the working rod 94.

In situations where the advance stroke of the working rod 94 suddenly becomes unconstrained, such as when the tooling attached to the end portion 50 has completed its function (e.g., piercing or shearing application where the material suddenly yields to the tool), the pressure in advance working chamber 100 will suddenly drop. This eliminates the back pressure acting against the intensification rod 98 and creates the possibility that the intensification piston 96 might lunge forward to the limit of its stroke, with the intensification piston 96 impacting the separator block. Enhanced hydraulic positioning control of the intensification piston 96 provides the ability to prevent such impact and also to proceed through the operating sequence as soon as the completion of the process has been detected.

Hydraulic fluid is communicated to the pressure cylinder 130 via ports, which are fluidly connected to the pressurized fluid supply assembly, which includes a motor (e.g., servomotor) rotationally driving a pump 156, such as a positive displacement pump. The pump 156 driven by a servomotor provides more precise control of speed and position. The pump pressure can have a wide range of 10 PSI to 300 PSI (or higher depending on the intensification ratio and seal pressure rating) as compared to a system operating from a typical shop air supply, enabling a reduced number of smaller cylinder bore sizes. An electric motor driven pump facilitates the control of position, speed and force. The system, with incompressible fluid, quickly and effectively blocks motion when power is removed, unlike a pneumatic cylinder which may be pulled from the returned position by gravity or move suddenly when compressed air is exhausted.

A supply passage 170 fluidly connects the fluid reservoir 164 to the pump 156 on the supply side of the pump 156. A pressurized fluid passage 172 fluidly connects a pressure side of the pump 156 to the first valve 168. A return passage 174 fluidly connects the first valve 168 to the fluid reservoir 164. In one example, a pressure relief circuit 176 fluidly interconnects the pressurized fluid passage to the return passage 174 that fluidly interconnects the first valve 168 to the fluid reservoir 164. The pressure relief circuit 176 is configured to normally block fluid flow with a pressure relief valve 166 from the pressurized fluid passage 172 to the return passage 174 but permit fluid flow from the pressurized fluid passage 172 to the return passage 174 above a predetermined pressure threshold. The pressure relief valve 166 is provided as a safety device so the system cannot be over-pressurized to a value that will exceed the operating limit rating.

An advance passage 178 fluidly connects is in communication with the first valve 168 to the advance working chamber 100.

The first valve 168 includes a first position configured to fluidly connect the pressurized fluid passage 172 to the return passage 174. A second position is configured to fluidly connect the pressured fluid passage 172 to the advance passage 178, and to fluidly connect the retract passage 180 to the return passage 174. A third position is configured to fluidly connect the advance passage 178 to the relief passage, and to fluidly connect the pressurized fluid passage to the retract passage.

In the example, a directional control valve (i.e., second valve) 152, is mounted to the second end block of the pressure cylinder 130. The second valve/directional control valve 152 is configured to selectively regulate fluid flow between first valve 168 and the advance intensification chamber 104. An intensification passage fluidly connects the directional valve 152 to the advance intensification chamber 104. The directional valve 152 includes a first position fluidly blocking fluid flow from the advance passage 178 to the advance intensification chamber 104, and a second position fluidly connecting the advance passage 178 to the advance intensification chamber 104. When the intensification rod 98 is retracted, the working rod 94 of pressure cylinder 130 may be stopped in any position by coordinating the first valve 168 and the pump 156. When the desired working rod 94 position has been achieved, the first valve 168 can be returned to its first position, which would stop hydraulic fluid returning to the fluid reservoir 164. With the hydraulic fluid blocked by the first valve 168, the motor and pump 156 would not need to be operated to maintain the working rod 94 position. This greatly reduces the proliferation of cylinder variations in a manufacturing facility because conventional air cylinders are mechanically configured to provide a specific combination of working stroke and retract stroke.

A retract passage 180 fluidly connects a retract port from the first valve 168 to the retract working chamber 102 and retract intensification chamber 106. An equalization circuit 186 is fluidly connected between the intensification passage 184 and the retract passage 180. The equalization circuit 186 includes a check valve configured to block fluid flow from the retract passage 180 to the intensification passage 184 but permit fluid flow from the intensification passage 184 to the retract passage via a flow metering orifice. The orifice is active when the second valve 152 is open, to provide some return pressure against both working and intensifying pistons 92, 96 to prevent piston drift. The orifice also provides a bypass for the fluid applied to the intensification piston 92 to establish a relationship between pump speed and intensification pressure.

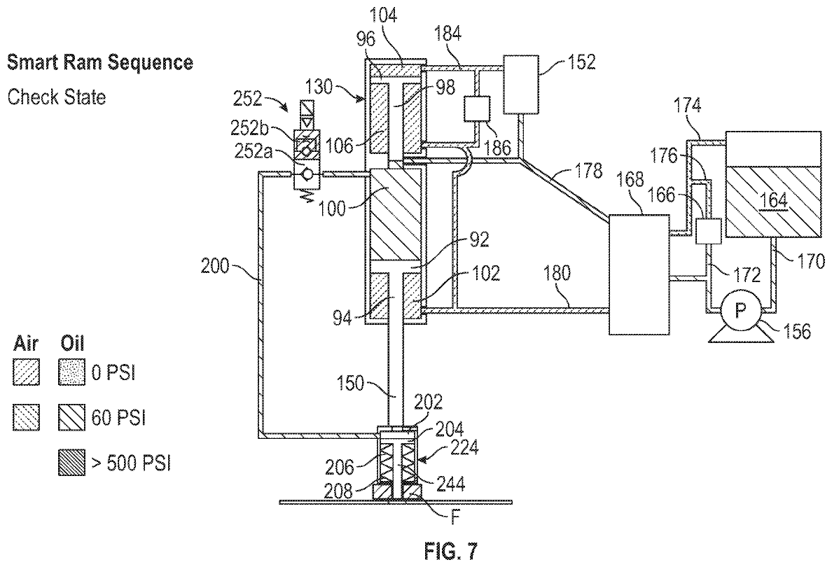

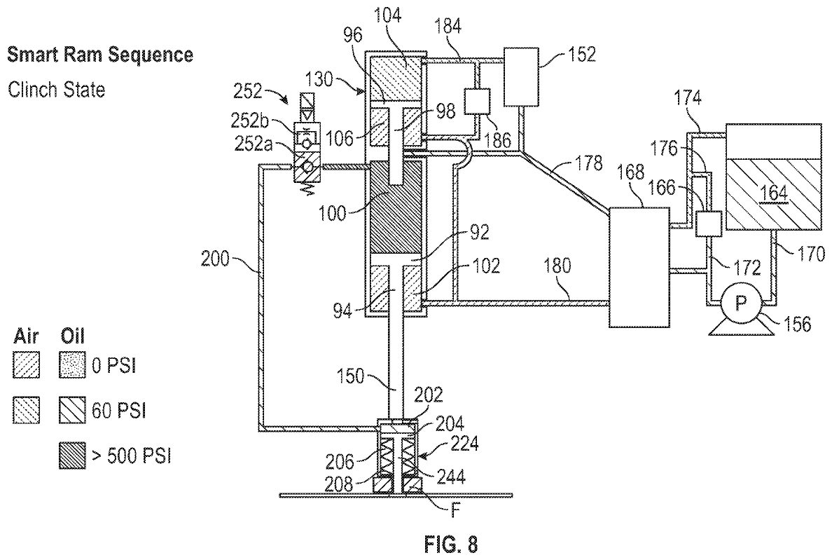

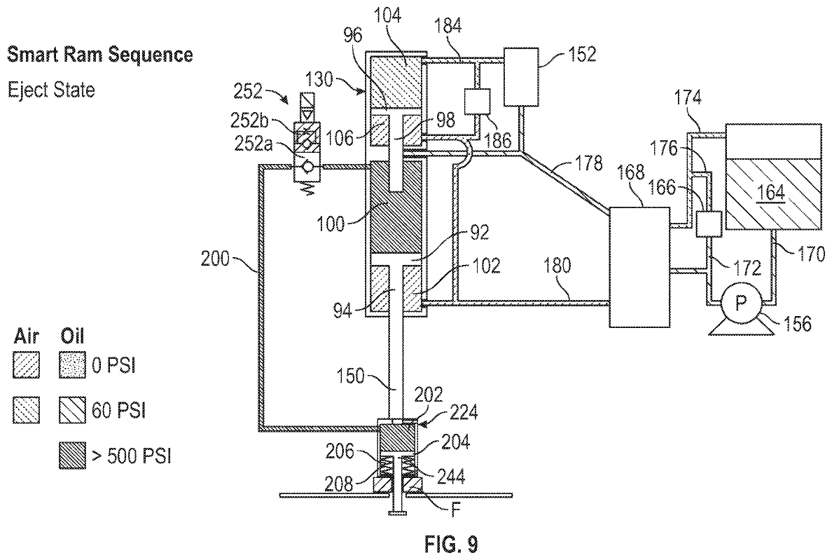

The controller 130 is configured to coordinate movement of the working piston 92 and the intensification piston 96 between a rest or retract state (FIG. 4), an advance state (FIG. 6), a check state (FIG. 7), an intensified or clinch state (FIG. 8), and an eject state (FIG. 9). The advanced state is configured to engage the head assembly 224 and its supported fastener F, with the workpiece. The intensified/clinch state is configured to perform an operation on the workpiece with the head assembly 224 and die 28.

Referring to FIGS. 4 and 5, the system is illustrated in a rest state, in which the working piston 92 and an intensification piston 96 are in the retracted positions. In this state, the first valve 68 is in a first position, which fluidly connects the pressurized fluid passage 172 to the return passage 174. The directional valve 152 is in a first position. The head assembly 224 houses a pin 244 (or “stripper pin”) that extends to a tip 245 and is slideably received within the head 226 such that the tip 245 extends out of the head 226 for supporting the fastener F on a face of the head 226. A magnet 250 may be provided on the head 226 to hold the fastener F in place on the tip 245. These magnet(s) 250 could be supplemented or replaced with other means such as spring retainers or vacuum for fastener retention.

The pin 244 is operatively connected to a piston 204, that separates a cavity within the head 226. A head advance chamber 202 is provided on one side of the piston 204 and is fluidly connected via a hydraulic line 200 to a pressurized fluid source, such as the advance working chamber 100. The hydraulic line between the blocking valve and the head assembly is a small diameter hydraulic hose assembly capable of operating to the pressure rating of the actuator.

A spring 208, such as a coil spring, is arranged in the head assembly 224 on a side 206 of the piston 204 opposite of the head advance chamber 202. The spring 208 urges the pin 244 to a normally fully returned position. During normal operation fluid is forced into head advance chamber 202 to push the slug through die 28 and into hole 37. The ejector pin 244 is made of a material with mechanical characteristics suitable for the application. This can be for example, hardness to resist deformation of the tip 245 under load, and a coating to reduce sliding friction. The ejector pin 244 may be fitted with a guide ring to keep it centered in the bore of the pin, and an enlarged section to guide the return (compression) spring 208 so its central axis remains aligned with the pin axis along its entire length.

The pin sensor 246 is arranged inside of the head assembly 224 and is coupled to the pin 244. In one example, the pin sensor 246 is a linear variable displacement transducer (LVDT) having a core 278 that is secured to a stop 274 affixed relative to the pin 244. The stop 274 and the core 278 are arranged in a cavity 272 within the head assembly 224. The pin 244 translates during operation in a unique manner based upon the fastener loaded onto the tip 245, the fastener's orientation and presence/absence, wear of press components, and the quality of the clinching operation (such as set-down travel measurement resulting in a clinch signature consisting of both travel distance and velocity).

A proximity sensor 252 may be integrated into the head assembly 224 for verification of fastener presence. The ejector pin extension and arrangement of magnets 250 and the proximity sensor 252 prevents the possibility that a fastener can be improperly loaded and activate the sensor. A fastener that is held in a canted position, or adjacent to the ejector pin by one or more magnets would not be close enough to the sensor to activate it.

The hydraulic line connects the advance working chamber 100 of through a blocking (2-way) valve 252 to the head advance chamber 202. The blocking valve 252 is normally opened (position 252a), and closed (position 252b) only when the fastener F is being installed. The advance working chamber 100 is at atmospheric pressure in the position illustrated in FIG. 4 as it is connected to the vented hydraulic fluid reservoir 164. In this case, the ejector pin return spring 208 will urge the ejector pin 244 to its fully retracted position, as shown in FIGS. 4 and 5.

To actuate the pressure cylinder 130 to an advancing state (FIG. 6), the first valve 168 is moved to a second position in which the pressurized fluid passage 172 is fluidly connected to the advance passage 178, and the retract passage 180 is fluidly connected to the return passage 174. Pressurized fluid flows from the pump 156 and pressurized fluid passage 172 to advance passage 1178 via the first valve 168 in its second position to provide pressurized fluid to the advance working chamber 100, which advances the working piston 92 and its working rod 94 toward the workpiece until the supported head assembly 224 engages the workpiece, as shown in FIG. 6.

At this point, the directional valve 152 is actuated to a second position, which enables pressurized fluid flow from the advanced passage 178 to the advance intensification chamber 104 via the intensification passage 184. As the intensification rod 98 advances through the bore in the separator block, flow from the advanced passage 178 is prevented from further flow into the advance working chamber 100.

Fastener installation occurs when the cylinder 130 is initially intensified and the head assembly 224 presses the fastener F into the workpiece towards the die 28 to form the mechanical (clinched) connection. At all other times, when the blocking valve is open (FIGS. 7 and 9), the hydraulic fluid pressure acting on the piston 204 within the head assembly 224 and the advance working chamber 100 are the same and will cause them to simultaneously advance or retract.

During the sequence shown in FIG. 7, the hydraulic fluid pressure acting on the piston 204, and against the ejector pin 244 will be low. The pressure supplied from the advance working chamber 100 to the head advance chamber 202 will advance the ejector pin 244 against the return spring 208 until force equilibrium is achieved. The ejector pin stroke is in the range of 3 mm-6 mm of extension in one example to provide enough initial stroke to push the tip 245 of the ejector pin 244 beyond the face of the fastener F, as shown in FIG. 8. Using either the servomotor pump 156 or a pneumatic regulator, the low-pressure value can be simply adjusted to achieve the desired ejector pin extension. This will position the tip 245 of the ejector pin 244 so it can contact the workpiece before the fastener.

At the low level of hydraulic pressure, the ejector pin 244 will remain responsive to encountered loads that may push it into the clinching head assembly 224. This responsiveness facilitates linear position sensing, including determination of the point at which there is initial contact of the ejector pin with the workpiece. The initial low-pressure stroke distance is not critical, and it can be the full limits of ejector pin stroke if for example the cylinder 130 close pressure is adjusted to a high initial value to minimize the time required to advance the head and fastener to the workpiece.

As the intensification rod 98 continues to advance into the advance working chamber 100 to the intensified state (8), the force across the working piston 92 and thus the working rod 94 significantly increases on the workpiece.

When the blocking valve is opened (position 252a) as shown in FIGS. 9 and 10 (slug eject position), the high pressure generated inside the advance working chamber 100 in the intensification cylinder 130 during the intensification sequence will act upon the eject piston 204 to force the ejector pin 244 to advance with substantial force. A common full stroke provided for this purpose is 15 mm. If desired, the high (intensification) pressure can be increased or decreased after the clinch has been completed, to control the force applied to the ejector pin.

Once the operation is completed, the intensification piston 96 and its respective intensification rod 98 are moved to a position where the intensification rod 98 permits the advance working chamber 100 to once again be fluidly connected to advanced passage 178, permitting the fluid in retract working chamber 102 to push against working piston 92 to force the fluid from the advance working chamber 100, back through the advance passage 178 and return passage 174. The first valve 168 is moved to a third position in which the advance working chamber 100 and advance intensification chamber 104 are exhausted through the first position of the directional valve 152, through the advanced passage 178, through the third position of the first valve 168, into the return passage 174 and back to the fluid reservoir 164. At the same time, a pressurized fluid from the pressurized fluid passage 172 is supplied through the third position of the first valve 168 to the retract passage 180 and into the retract working chamber 102 and retract intensification chamber 106, which are at higher relative pressures than the advance working chamber 100 and the advance intensification chamber 104.

Once the clinch fastener has been installed, the intensification pressure could intentionally be increased or decreased to provide more or less force on the ejector pin. Higher force may be desired for example, to minimize the time provided for the ejector pin to break any bonds. Lower force may be desired for example to permit the slug to stretch and yield the bonds while minimizing the force applied on the fastener and tooling by the pin. When the control determines the sequence is complete based on the signature of the ejector pin movement or attainment of a stroke position, the cylinder 130 can be retracted. Otherwise, the operating sequence can provide time sufficient for each phase to complete under normal circumstances. In either case, supplemental means may be provided to detect that the slug has been displaced or is no longer attached to the assembly.

Prior to intensifying the actuator, the blocking valve must be actuated to isolate the actuator working piston advance chamber from the hydraulic piston in the clinch pin tool. This will trap low pressure hydraulic fluid in the clinch head assembly. Any change in the ejector pin extension will then be indicative of a number of workpieces, fastener, and tooling conditions, as summarized in the following table.

| Clinch | Ejector | Fastener | | |
|---|---|---|---|---|
| Tool | Pin | Sensor¹ | Feeder² | Condition Detected |
| Returned | Returned | N.S. | Lowered | Home position |
| Returned | Not fully | N.S. | Lowered | Ejector pin position fault |
| | returned | | | 1. Mechanical issue |
| | | | | 2 Blocking valve is not |
| | | | | opened |
| Returned | Returned | Off | Not fully | 1. Incorrect fastener - hole |
| | | | Raised | too small for ejector pin |
| | | | | 2. Feeder misaligned with |
| | | | | ejector pin |
| Returned | Returned | On | Not fully | 1. Fastener too thick |
| | | | raised | 2. Contamination on pin |
| | | | | face or fastener - likely |
| | | | | metal adhered to magnets |
| | | | | embedded in the pin face |
| Returned | Returned | Off | Raised | No fastener present |
| Returned | Returned | On | Raised | Fastener correctly loaded |
| Not | Returned | On | N/A | Would generally be |
| returned | | | | considered a fault because |
| (advancing | | | | there would be no capability |
| under low | | | | for the ejector pin to move, |
| force) | | | | and therefore, no capability |
| | | | | to detect many attributes and |
| | | | | faults. Likely indicates: |
| | | | | 1. The advance pressure is |
| | | | | too low to overcome the |
| | | | | ejector pin return spring. |
| | | | | 2. There is entrained air |
| | | | | between the actuator and |
| | | | | the hydraulic piston |
| | | | | 3. The blocking valve is |
| | | | | closed when it should not |
| | | | | be. |
| | | | | If linear position sensing of |
| | | | | the ejector pin is not being |
| | | | | employed, this will not |
| | | | | equipment impair operation. |
| Not | Advancing | Off | N/A | Fastener presence fault - |
| returned | to low | | | advancing the ejector pin |
| (advancing | pressure | | | may have caused the |
| under low | position | | | fastener to dislodge while |
| force) | | | | the pin is in transit to the |
| | | | | workpiece. |
| Not | Advanced to | On | N/A | Ready for ejector pin |
| returned | low pressure | | | position sensing. |
| (advancing | position | | | |
| under low | | | | |
| force) | | | | |
| Not | Depressed | On | N/A | Collision detected |
| returned | from low | | | |
| (advancing | pressure | | | |
| under low | position | | | |
| force) | | | | |
| Not | Advanced to | On | N/A | Conditions discernable using |
| returned | low pressure | | | linear position history. |
| (after | position | | | 1. No workpiece present. |
| sufficient | | | | 2. Ejector pin was not |
| time to | | | | extended beyond |
| advance | | | | fastener. |
| under low | | | | 3. Fastener too thick. |
| force) | | | | 4. Fastener or pin has |
| | | | | contamination. |
| Not | Depressed | On | N/A | Workpiece, die, and fastener |
| returned | from low | | | present - ready for |
| (advanced | pressure | | | application of clinching force |
| under low | position | | | |
| force) | | | | |
| Not | Depressed | N.S. | N/A | Verification of clinch travel or |
| returned | from pre- | | | clinch travel signature. |
| (advanced | clinch | | | |
| under high | position | | | |
| force) | | | | |

¹N.S. = not specified
²N/A = not applicable

The cylinder 130 can then be intensified to cause the fastener to pierce the workpiece and form the mechanical connection. After sufficient time, or by using linear sensing of upper ram and/or ejector pin stroke, the blocking valve 252 can be opened to cause the ejector pin to advance to its full stroke. The hydraulic fluid volume is low so there does not normally need to be any additional provision of intensification stroke length in the actuator. Since the clinching operation is completed, there is the possibility that the intensification force can be reduced or raised so the ejector pin applies a correspondingly lower or higher force against the retained slug.

When the fastener installation process is complete, the actuator will be returned. This is accomplished in two phases. When the intensification piston is retracted, it will withdraw any hydraulic fluid displaced by the intensification piston rod. This action will cause hydraulic fluid supplied to advance the piston 204 to be withdrawn and thereby the ejector pin 244. This will have the effect of extracting the ejector pin 244 from the workpiece before the working rod 94 has any appreciable movement. The working piston 92 movement may be the distance of the high-pressure stroke but, this will virtually eliminate any possibility that withdrawing the ejector pin can put undesirable loading on the workpiece, should there be binding or engagement.

With the addition of upper ram stroke position (clinch head assembly travel distance) the following table describes the additional conditions that can be detected.

| Clinch | | |
|---|---|---|
| Tool | Ejector Pin¹ | Condition Detected |
| Partial or | N.S. | Unintended impact during pin |
| interrupted | | travel. |
| advance | | |
| Advanced | N.S. | 1. Determination of pre-clinch |
| under low | | pin position |
| force | | 2. Confirmation of standard |
| | | workpiece and fastener |
| | | stack-up height |
| Advanced | Depressed | Confirmation of workpiece |
| under low | from low | presence |
| force | pressure | |
| | position | |
| Advanced | N.S. | 1. Measurement of pin travel |
| under | | during clinching |
| clinching | | 2. Pin displacement signature |
| force | | during clinching |
| Advanced | Depressed | Incomplete slug pierce |
| under | from pre- | |
| clinching | clinch pin | |
| force | position | |
| Advanced | P2 - Partial | Clinch successful and slug |
| under | extension | hung-up. Misaligned or worn |
| clinching | beyond | die button; defective fastener |
| force | pre-clinch | |
| | position | |
| Advanced | P3 - Full | Clinch successful and slug |
| under | extension | clear |
| clinching | | |
| force | | |

¹N.S. = not specified

FIGS. 5 and 10 illustrate a configuration in which the pin 244 and piston 208 are coaxial with one another. In operations where there are tighter clearances, it may be desirable to use an offset pin/piston head assembly 324 as shown in FIG. 11. In that example, the spring 308 is arranged beneath and coaxial with the pin 344. The tip 345 of the pin 344 supports the fastener F as described above. The stop 374 is affixed to the pin 344 and the piston 304 is operative connected to the stop 374 so the pin 344 and piston 304 move in unison with one another in response to pressure in head advance chamber 302 and force of the spring 308. The pin sensor 346 may be secured to the stop 374 coaxially with the pin 344 (as shown) or offset.

The disclosed head assemblies address practical issues of clinch fastener installation. Component thickness can vary. Sheet metal mill tolerances of 10% are common and coated materials may have more variation. Forming of the workpiece shape may result in localized thickening or thinning of the workpiece. Fastener dimensional consistency can vary. Shear consistency can be affected by variations in the shear edge profiles, dimensions, and thickness. If the shear edge sharpness is reduced, the shearing action of the fastener will be less effective. A dimension change will effectively change the die clearance. And, if the fastener protrusion is short then the shear length will be reduced. Some users are inclined to purchase a reduced number of clinch fasteners instead of buying very similar fasteners that match each specific sheet metal thickness. This reduces the number of clinch fastener part numbers they have to track and stock, with negligible impact on the final product performance.

These issues lead to instances where the clinch fastener does not have sufficient penetration into the sheet metal workpiece to completely dislodge the pierced slug. In some instances the force produced by a pin ejector spring might need to be very high in order to clear the slug. When the fastener only pierces partially through the workpiece, the ejector pin needs to be able to apply enough force to stretch the workpiece base metal until it reaches its yield point. Significant challenges that would result from using a heavy compression spring to provide such high forces include: A die spring would need to be physically quite large-increasing the size and mass of the tooling. The high force applied to the ejector pin would reduce the effectiveness of the fault monitoring system because the ejector pin would be unlikely to move during the low force approach stroke of the actuator. The likelihood of fastener and tooling damage would increase if faults could not be detected with the actuator supplying a low value of force. The ejector pin would likely deform and stress the workpiece (press it into the die) before the fastener engages the workpiece. The slug produced during the installation of a self-piercing clinch nut needs to be cleared from the workpiece because it may inhibit a screw from being installed to its full depth, thereby failing to firmly secure the joint as intended. It is undesirable to push out the slug at the time of final assembly because the slug could end up somewhere undesirable if it is later dislodged. The process of trying to remove a slug from a fastener that has been rendered inaccessible by a previous assembly step, can be risky because the work might weaken the connection or displace the fastener, and render the assembly unusable. Or the slug could become loose within the assembly and cause objectionable noise or wear. If the assembly with clinch fasteners has been integrated into a much larger assembly, such as an automobile, before the condition has been identified, the cost of rework or scrap can be extremely high. The clinch fastener installation process needs to be reliably consistent to avoid the extra expense, time, and space associated inspection, rework, and scrap.

The above issues are addressed by the disclosed clinching head assembly and method of operation. The method includes positioning a fastener beneath a head assembly with a pin extending into and in engagement with the fastener. The head assembly and the pin are advanced toward a die, and a workpiece between the die and the head assembly are engaged to pierce the workpiece with the fastener during a clinching operation. In the example, the advancing step and the engaging step are performed by advancing a ram to which the head assembly is mounted. The ram has an advance working chamber receiving hydraulic fluid during the engaging step. Hydraulic fluid is supplied to the head assembly by a valve fluidly connecting the advance working chamber and a hydraulic chamber in the head assembly to advance the pin and push a slug from the workpiece through the die. The supplying step is prevented during the engaging step. The pin is urged to a retracted position by the spring with the head assembly in a retracted position, ready for another cycle.

The uniqueness of the disclosed approach is the exploitation of the high-pressure hydraulic fluid in the clinching actuator cylinder 130 to provide a boost to the ejector pin thrust. The use of a blocking valve 252 provides control over the timing of the increase in ejector pin force so the fastener installation can be completed without undue strain on the workpiece. The slug can be separated from the workpiece while the workpiece and fastener are fully engaged with the clinch (installation) tooling and installation force is maintained. This minimizes the possibility that strain on the workpiece could affect the integrity of the connection. Full control over the pressure applied at each phase (closing, clinching, and slug stripping) is maintained. The ejector pin will be withdrawn from the workpiece prior to the clinch tooling making any appreciable movement away from the workpiece. This prevents any skewing of the fastener thread on the ejector pin and the possibility of binding.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

1. A clinching press for performing a clinching operation to secure a fastener to a workpiece, the fastener clinching press comprising:
a frame supporting a die having a hole configured to cooperate with the fastener to produce a slug from the workpiece;
a pressure cylinder supported by the frame, a ram extending from the pressure cylinder and configured to move between a returned position and an advanced position;
a head assembly mounted to the ram and configured to engage the fastener in the advanced position, a pin slidably supported within the head assembly and extending out of the head assembly to a tip that is configured to locate the fastener relative to the die, the pin movable between multiple pin positions including a slug-eject position;
wherein the head assembly includes an eject piston arranged in a hydraulic cylinder, a hydraulic chamber is arranged on one side of the eject piston and is configured to receive a hydraulic fluid, the pin is operatively connected to the eject piston;
a valve fluidly interconnected between a hydraulic fluid source and the hydraulic chamber, the valve configured to selectively provide the hydraulic fluid to the hydraulic chamber; and
a controller in communication with the valve, the controller configured to command the valve to supply the hydraulic fluid to the hydraulic chamber with the ram in the advanced position to move the pin to the slug-eject position.

2. The clinching press of claim 1, wherein the pressure cylinder includes a working cylinder having a working piston arranged therein and connected to a working rod providing the ram, the working piston separating the working cylinder into an advance working chamber and a retract working chamber, the advance working chamber is in fluid communication with the hydraulic fluid source.

3. The clinching press of claim 2, wherein the pressure cylinder includes a an intensification cylinder divided from the working cylinder by a separator block, an intensification piston and an intensification rod arranged in the intensification cylinder, the intensification piston separating the intensification cylinder into an advance intensification chamber and a retract intensification chamber, the intensification rod configured to be disposed in the advance working chamber in an intensified state.

4. The clinching press of claim 3, comprising an fluid source in fluid communication with the retract working chamber and the retract intensification chamber.

5. The clinching press of claim 3, comprising an fluid source in fluid communication with the advance intensification chamber.

6. The clinching press of claim 3, wherein the intensified state corresponds to a clinch state in which the fastener is secured to the workpiece, and the controller commands the valve to supply the hydraulic fluid to the hydraulic chamber in the intensified state.

7. The clinching press of claim 2, wherein the valve fluidly interconnects the advance working chamber and the hydraulic chamber.

8. The clinching press of claim 1, wherein the head assembly includes a return spring operatively connected to the piston on a side opposite the hydraulic chamber.

9. The clinching press of claim 8, wherein the return spring is coaxial with the eject piston.

10. The clinching press of claim 8, wherein the eject piston is coaxial with the pin.

11. The clinching press of claim 1, wherein the valve is a directional valve including:
a first position fluidly blocking fluid flow from the hydraulic fluid source to the hydraulic chamber; and
a second position fluidly connecting the hydraulic fluid source to the hydraulic chamber.

12. The clinching press of claim 1, wherein the head assembly includes a magnet configured to maintain the fastener in engagement with the head assembly during the clinching operation.

13. The clinching press of claim 1, comprising a fastener feeder having a shuttle with an end configured to receive a fastener, the shuttle mounted to a shuttle cylinder configured to move the shuttle between a shuttle extended position and a shuttle retracted position, and a lift cylinder configured to pivot the shuttle cylinder between a first position configured to arranged the fastener in spaced relation to the head assembly and a second position configured to arrange the fastener in engagement with the head assembly.

14. An assembly cell including the clinching press of claim 1, the assembly cell comprising a multi-axis robot configured to transfer the workpiece to and from the clinching press for the clinching operation.

15. The assembly cell of claim 14, comprising a conveyor configured to feed the workpiece to the multi-axis robot.

16. A method of performing a clinching operation, comprising:
positioning a fastener beneath a head assembly with a pin extending into and in engagement with the fastener;
advancing the head assembly and the pin toward a die;
engaging a workpiece between the die and the head assembly with an installation force to pierce the workpiece with the fastener during a clinching operation; and
supplying hydraulic fluid to the head assembly to advance the pin and push a slug from the workpiece through the die with a pin force that completely separates the slug from the workpiece while maintaining the clinching force on the workpiece.

17. The method of claim 16, wherein the supplying step is prevented during the engaging step.

18. The method of claim 16, wherein the advancing step and the engaging step are performed by advancing a ram to which the head assembly is mounted, the ram having an advance working chamber receiving hydraulic fluid during the engaging step.

19. The method of claim 16, wherein the supplying step is controlled by a valve fluidly connecting an advance working chamber and a hydraulic chamber in the head assembly.

20. The method of claim 16, comprising the step of urging the pin to a retracted position with the head assembly in a retracted position.
